(19) United States
(12) Patent Application Publication
(10) Pub. No.: US 2022/0229409 A1
(43) Pub. Date: Jul. 21, 2022

(54) MOBILE DEVICE AND SYSTEM FOR MANAGING SAFETY OF CRITICAL COMPRESSED GAS ASSETS AND OPERATIONS

(71) Applicant: Bauer Compressors, Inc., Norfolk, VA (US)

(72) Inventors: Anthony B. Bayat, Virginia Beach, VA (US); Neil S. Patel, Virginia Beach, VA (US); Eshwar Krishna Chigurupati, Norfolk, VA (US)

(21) Appl. No.: 17/232,580

(22) Filed: Apr. 16, 2021

Related U.S. Application Data
(63) Continuation-in-part of application No. 17/154,408, filed on Jan. 21, 2021.

(51) Int. Cl. G05B 19/048; G05B 23/02

(52) U.S. Cl. CPC G05B 19/048; G05B 2223/06; G05B 2219/41108; G05B 23/0208

(57) ABSTRACT

A method and mobile device are provided for managing safety aspects associated with assets of a compressed gas system. The mobile device captures a unique identifier coupled to and associated with an asset of a compressed gas system, establishes a wireless connection with a remote database storing historical data associated with the asset, and displays prompts related to the asset where the prompts include asset-inspection-criteria prompts. User-supplied responses to the prompts are received at the mobile device. The mobile device then transmits the responses via the wireless connection to the remote database for inclusion with the historical data associated with the asset.

This is a continuation-in-part application of co-pending application Ser. No. 17/154,408, “MOBILE DEVICE AND SYSTEM FOR MANAGING SAFETY OF GAS CYLINDER FILL OPERATIONS”, filed on Jan. 21, 2021.

### FIELD OF THE INVENTION

The invention relates generally to safety management, and more particularly to a mobile device and system for managing the safety aspects of critical compressed gas assets and operations such as those associated with breathing-air systems.

### BACKGROUND OF THE INVENTION

A variety of industries and applications utilize re-fillable cylinders for the containment and dispensing of a compressed gas. For example, compressed gas in the form of breathing air is used with self-contained breathing apparatus (SCBA). As is known in the art, SCBA is a general term used to refer to a variety of devices worn by rescue workers, firefighters, underwater divers, and others for the purpose of supplying breathing air to an individual who is operating in an environment that presents an immediately dangerous or unhealthy breathing atmosphere. One of the primary and critical assets of an SCBA system is a tank or cylinder filled with compressed breathing air that must be re-filled when empty. SCBA cylinder re-filling generally occurs at a user's facility (e.g., firehouse or station) or in the field of operation using a variety of types of breathing-air filling systems.

To protect the health and safety of users of SCBAs as well as those re-filling SCBA cylinders, numerous governmental regulations and reporting requirements have been promulgated and must be adhered to by both users and fillers of SCBA cylinders. Unfortunately, the wide variety of SCBA cylinders, filling systems, and filling locations/stations, can make it difficult or impossible to manage and satisfy all regulations and reporting requirements associated with gas cylinder filling operations. Furthermore, combining the above-noted variables with human error can lead to improper filling of an SCBA cylinder that presents a safety concern for filling personnel and/or a user of an improperly filled SCBA cylinder.

SCBA systems also include a variety of other critical assets whose safety is an important part of any ongoing monitoring and management system. In terms of SCBA systems, some of these critical assets are the compressors used to fill SCBA cylinders, the air packs and masks that are coupled to an SCBA cylinder to allow a user to receive the breathing air, physical cylinder support assets on which an SCBA cylinder is mounted to facilitate the wearing thereof during an operation, and specially-designed clothing worn by a user during an operation requiring the use of an SCBA system, just to name a few.

### SUMMARY OF THE INVENTION

Accordingly, it is an object of the present invention to provide a management tool that simplifies adherence to safety regulations and reporting requirements associated with a variety of critical assets and operations associated with breathing-air systems.

Another object of the present invention is to provide a management tool that improves the safety of critical breathing-air assets and operations as well as satisfying governmental inspection and reporting requirements associated therewith regardless of where the asset is located.

Other objects and advantages of the present invention will become more obvious hereinafter in the specification and drawings.

In accordance with the present invention, a method and mobile device are provided for managing safety aspects associated with assets of a compressed gas system. The mobile device captures a unique identifier coupled to and associated with an asset of a compressed gas system. The mobile device establishes a wireless connection with a remote database storing historical data associated with the asset. The mobile device displays prompts related to the asset where the prompts include asset-inspection-criteria prompts. User-supplied responses to the prompts are received at the mobile device. The mobile device transmits the responses via the wireless connection to the remote database for inclusion with the historical data associated with the asset.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a block diagram of a mobile device and system for managing the safety aspects of critical compressed gas assets and operations in accordance with an embodiment of the present invention;

FIG. 2 is a side view of a portion of a compressed gas cylinder having identifying tag(s) coupled thereto;

FIG. 3 is a flow diagram of the methods implemented by the mobile device illustrated in FIG. 1 as they relate to compressed gas cylinders in accordance with an embodiment of the present invention;

FIG. 4 is a flow diagram of the methods implemented by the mobile device illustrated in FIG. 1 requiring an active form of user attestation in accordance with another embodiment of the present invention;

FIG. 5 is a flow diagram of the methods implemented by the mobile device illustrated in FIG. 1 that includes the download of historical cylinder data to the mobile device in accordance with another embodiment of the present invention;

FIG. 6 is a flow diagram of the methods implemented by the mobile device illustrated in FIG. 1 that prevents further processing if a cylinder is out of compliance or has previously been marked as failed in accordance with another embodiment of the present invention; and

FIG. 7 is a flow diagram of the methods implemented by the mobile device illustrated in FIG. 1 as they relate to a variety of other critical non-cylinder breathing-air system assets in accordance with another embodiment of the present invention.

### DETAILED DESCRIPTION OF THE INVENTION

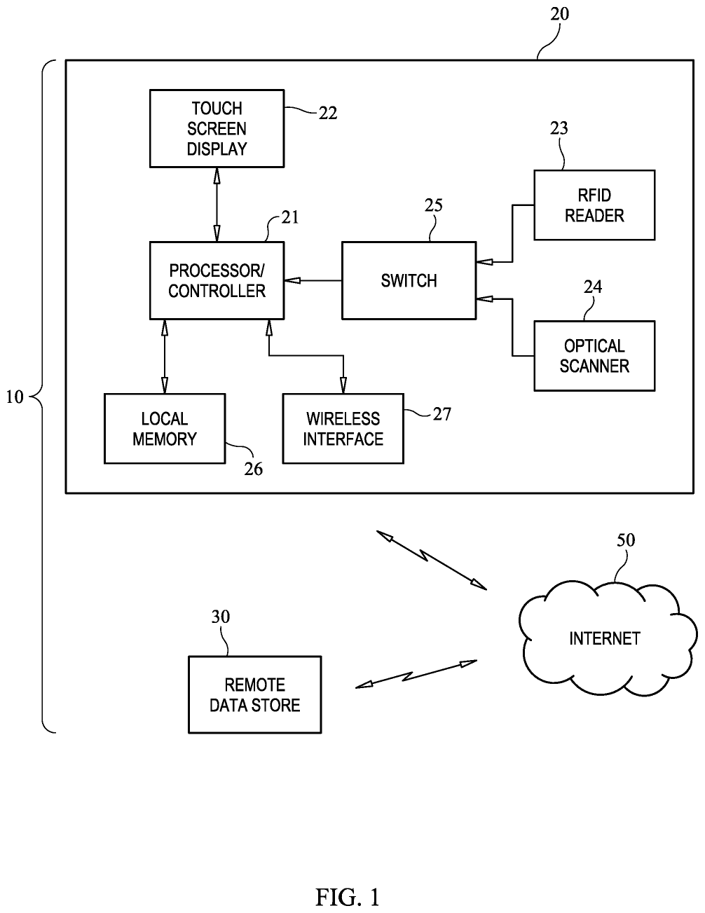

Referring now to the drawings and more particularly to FIG. 1, a mobile device and system that provides for the management of safety aspects associated with critical compressed gas assets and operations in accordance with an embodiment of the present invention is shown and is referenced generally by numeral 10. The compressed gas can be breathing air, pure oxygen, or any other gas without departing from the scope of the present invention. By way of an illustrative example, system 10 will first be described for its utility in compressed gas cylinder fill operations for breathing-air systems such as SCBA systems. However, it is to be understood that the present invention can also be adapted for management of the safety aspects of other critical assets used in breathing-air systems as will be described later herein.

System 10 includes a mobile electronic device 20 and a remotely-located data store 30 (e.g., a remotely-located database facility providing what is known as cloud-based data storage) for storing historical data associated with all critical assets (e.g., breathing-air cylinders in the illustrated example) owned by a fire department, a hospital system, or other organization owning breathing-air systems. Such historical data can include each asset's identification, “born on” date, “end of life” date, hydrostatic testing history in the case of cylinders, previous filling data in the case of cylinders, etc.

As will be explained further below, both device 20 and data store 30 are capable of communication with one another via the internet 50. Such communication facilitates data transfer between device 20 and data store 30, and can be carried out in a wireless fashion as would be well understood in the art. The configuration of data store 30 and any of its supporting components can be realized in a variety of ways known to those skilled in the art without departing from the scope of the present invention.

Device 20 can be a self-contained hand-held device thereby making it readily available for use by, in the exemplary embodiment, a cylinder filling operator utilizing any compressed gas filling apparatus at any filling location. Device 20 can comprise any dedicated or multi-purpose portable electronic device having the attributes that will be described herein. In general, device 20 is a portable or mobile electronic device configured to
provide a filling operator the means to recognize or register a compressed gas cylinder,
prompt the filling operator to verify and attest to cylinder data and critical safety criteria (e.g., criteria specified by one or more gas cylinder regulating entities, criteria specified by the owners of the gas cylinders to be filled, criteria specified by the owner of device 20, etc.),
prompt the filling operator to enter specific gas cylinder fill data if the critical safety criteria is verified and attested to by the filling operator, and
automatically transmit user-supplied responses to the prompts and other data to remotely-located data store 30.

The prompts related to critical safety criteria for a cylinder will generally identify a variety of inspection criteria that must be verified and attested to by a cylinder fill operator in order for a gas cylinder owner (e.g., a fire department) to be in compliance with guidelines and/or requirements. The inspection criteria can be established by one or more relevant regulating entities such as the National Fire Protection Association (NFPA) and/or the Occupational Safety and Health Administration (OSHA), as well as any in-house guidelines/requirements specified by the owner of the gas cylinder and/or the owner of the mobile device described herein.

In the illustrated embodiment, device 20 has a number of hardware components to include a processor or controller 21, a touch screen display 22, a “radio frequency identification” (RFID) reader 23, an optical scanner 24, a switch 25 for selecting one of multiple data-reading input devices (e.g., an RFID reader 23 or optical scanner 24), a local data-storing memory 26, and a wireless interface 27 (e.g., one or more hardware components configurable to support one or more of Bluetooth, near-field communication, cellular, and/or WIFI protocols). Device 20 could also have a single reading component (e.g., RFID reader 23 or optical scanner 24) without departing from the scope of the present invention. Although not shown, device 20 will also typically include a housing, a power source (e.g., battery(ies), a port for the coupling of an external AC power source, etc.), and/or additional supporting electrical and mechanical features whose choice and inclusion in device 20 would be well understood in the art.

Processor 21 is representative of one or more processors, or functionally equivalent hardware or software components, that can perform one or more of the functions to be described herein. Local memory 26 is operatively coupled to processor 21 and is representative of one or more memories that can be used to store data and can also function as a computer-readable storage medium that stores computer-executable instructions that govern operations of device 20 in accordance with the methods described herein. Processor 21 could also include its own integrated memory for storing the computer-executable instructions without departing from the scope of the present invention.

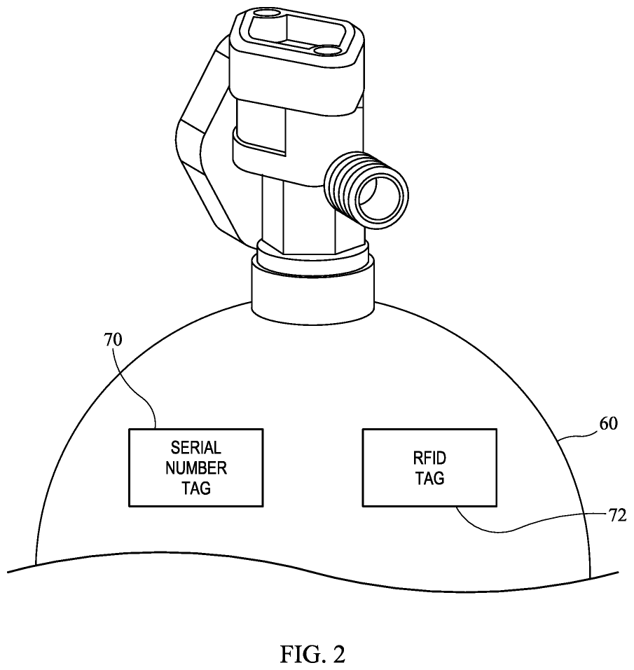

Device 20 will be used by a filling operator prior to the filling of a gas cylinder with compressed gas. A portion of a typical compressed gas tank or cylinder 60 is illustrated in FIG. 2. As is known in the art, compressed gas cylinders typically have one or more identifying tags coupled or affixed thereto that uniquely identifies the particular gas cylinder. At a minimum, every compressed gas cylinder has a serial number tag 70 affixed somewhere thereon at the time of its manufacture. Tag 70 can include alphanumeric characters, a bar code, a QR code, or any other “code” that can be read by an optical reader to indicate the cylinder's serial number. Once placed in use, many gas cylinders have an RFID tag 72 affixed to, coupled to, or integrated with cylinder 60. At a minimum, RFID tag 72 has a unique identifier stored thereon that is associated with the particular gas cylinder serial number specified on tag 70. As will be explained further below, this association is maintained in data store 30. In some embodiments and as disclosed in U.S. Pat. No. 10,867,729, the RFID tag associated with a gas cylinder can advantageously store only the tag's unique identifier with all relevant data concerning the gas cylinder being stored in, accessed from, and updated in, a remotely-located database such as data store 30.

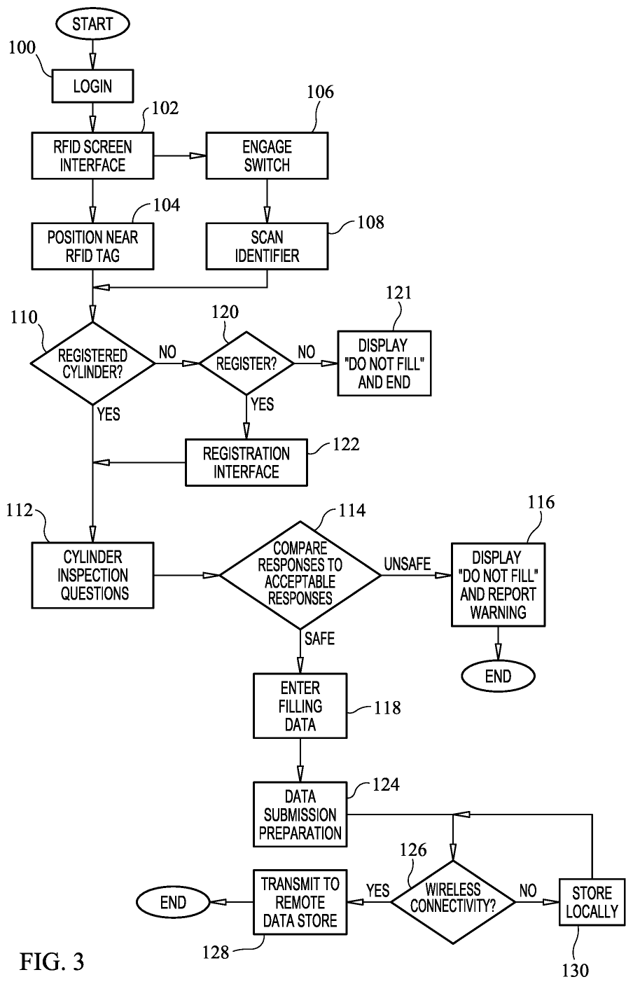

Referring additionally now to FIG. 3, an exemplary processing flow executed by device 20 during the use thereof for a cylinder fill operation is shown. The processing methodology is generally incorporated into computer-executable instructions stored on device 20 and executed by processor 21. The essential features of the processing methodology are depicted in FIG. 3.

At the start of processing, a user enters login credentials at step 100 using touch screen display 22. Following a properly validated login event, step 102 causes display 22 to present a screen/interface that assumes that the gas cylinder that is to be filled has an RFID tag (not shown) coupled thereto. Such login processing and validation operations are well understood in the art.

Assuming the gas cylinder to be filled has an RFID tag coupled thereto, a fill operator (or “user” as they will be referred to hereinafter) is instructed at step 104 to position device 20 close to the RFID tag whereby RFID reader 23 can read the RFID tag's identifier. Such instruction can come via a visual cue presented on display 22 and/or using an audible or tactile cue. Switch 25 can be set to a default position that selects RFID reader 23 as the data-reading input device of device 20 since many gas cylinders have RIFD tags affixed or coupled thereto.

If the gas cylinder to be filled does not have an RFID tag associated therewith, it will still have a serial number tag 70 (illustrated in FIG. 2) affixed thereto. As mentioned above, any alternative identification tag capable of being read by optical scanner 24 is acceptable. When this scenario is presented to the user, switch 25 is engaged at step 106 to select optical scanner 24 as the data-reading input device for device 20. Switch 25 can be any of a variety of user-controlled switch devices (e.g., toggle switch, shake-activated switch, etc.) without departing from the scope of the present invention. Once optical scanner 24 is selected, the user is instructed at step 108 to position device 20 to scan the identification tag. Such instruction can come via a visual cue presented on display 22 and/or using an audible or tactile cue.

The gas cylinder's identifier read at either step 104 or 108 is used to query remotely-located data store 30 at step 110 to see if the gas cylinder is registered. Briefly, processor 21 passes the cylinder's identifier to wireless interface 27 for transmission to remotely-located data store 30 that, in turn, compares the cylinder's identifier with those already stored in the data store's database. Remotely-located data store 30 provides a transmission back to device 20 to indicate if the cylinder is already registered or if it is not registered. If the cylinder's identifier is registered in the aforementioned database and there is no previously-recorded inspection failure warning (to be explained further below) associated with the identified cylinder, processor 21 causes display 22 to present the user with a number of prompts that are “cylinder inspection questions” (CIQs) at step 112. The CIQs can prompt a user to verify certain data about the cylinder as well as prompt the user with a series of critical visual or other inspection criteria that must be answered/attested to by the user. The CIQs can be configured/customized based on a regulatory entity's requirements and, if desired, based on a customer's needs and/or policies. By way of a non-limiting illustrative example, the CIQs could include the following inspection checklist or criteria requiring a “YES” or “NO” response from the user:
Does the cylinder have an inoperable or damaged valve?
Does the cylinder have any damage to its body?
Are any of the cylinder's threads damaged?
Is the cylinder's locking collar damaged?

A user must respond to all CIQs before the process will flow to its next step. In this way, the user-supplied responses can serve as a passive type of attestation to the stated inspection criteria. As will be explained further below, active user attestation can also be employed. Once all CIQs have been answered, processor 21 compares (at step 114) the user-supplied responses to pre-determined acceptable responses to the CIQs where the acceptable responses are indicative of a safe gas cylinder. Processor 21 identifies if there are any discrepancies between the user-supplied responses to the CIQs and the pre-determined acceptable responses. For example, if all CIQs are constructed to have a YES or NO answer and at least one user-supplied response does not match the predetermined acceptable response, a discrepancy is identified.

In cases where one or more discrepancies are identified, device 20 generates a cylinder-fail warning indicator indicative of an unsafe gas cylinder and displays a warning message on display 22 (e.g., a “DO NOT FILL” message). Device 20 then transmits the user-supplied responses along with the cylinder-fail warning indicator for the particular cylinder to remotely-located data store 30 via wireless interface 27 at step 116 and processing ends for the particular cylinder. In this way, the historical data associated with the particular gas cylinder stored at data store 30 is updated such that the gas cylinder is notated for repair or removal from service. The updated historical data is available immediately for review by cylinder owner administrators having access to data store 30. Furthermore, since discrepancies between the user-supplied responses and the acceptable responses causes processing to end with step 116, subsequent processing steps are prevented. Specifically, discrepancies between the user-supplied responses and the acceptable responses prevents the display of any prompts related to the entry of gas cylinder filling data at step 118 as will be described further below.

When there are no discrepancies between the user-supplied responses to the CIQs thereby indicating that the gas cylinder is safe for filling, processing proceeds to step 118 where the user is presented with prompts on display 22 identifying cylinder filling information or data that needs to be entered. By way of non-limiting examples, such cylinder filling data can include the time/date of filling, the compressor system that will be used to fill the gas cylinder, the fill pressure, the filling location, the filler's name, etc. The fill information can be presented to a user for confirmation prior to continuing.

Referring again to step 110, if a cylinder's identifier (e.g., RFID identifier, cylinder serial number, etc.) is not registered in the remotely-located database, the user is given the option to register the cylinder at step 120. If the user elects not to register the cylinder, processing proceeds to the above-described step 112 where CIQs are presented on display 22 and the entered data to include the cylinder's serial number is tagged as a “GUEST” fill for ultimate transmission to the remotely-located database. If registration is desired, a registration interface is presented on display 22 at step 122 with user-entered information transmitted to the remotely-located database and processing then proceeds to step 112. The user-entered information can include the cylinder's “born on” date, its maximum fill pressure, etc. Registration interface 122 can include instructions for a user to associate a new RFID tag with the cylinder's serial number for future identification and filling operations. If a user does not respond “YES” to registration step 120, a “DO NOT FILL” (or comparable) message is displayed at step 121 and processing ends for the cylinder.

Fill data that is entered at step 118 is prepared for submission at step 124. For example, the present invention can prepare the user-supplied response data for cooperation with a unique “handshake” operation to insure the integrity of the data reporting and logging made possible by device 20. Briefly, the collected data associated with a cylinder can be transferred to data store 30 using any secure data transfer protocol as would be well-understood in the art. Additionally or alternatively, submission preparation step 124 could include the automatic association of a permanent current-date stamp with the user-supplied response data to thereby provide confidence in the reported response data.

After the fill data is prepared for submission, device 20 (via processor 21 and wireless interface 27) monitors the availability of wireless connectivity at step 126. For example, if an internet connection is available, processor 21 issues instructions to wireless interface 27 to transmit the user-supplied response data to remotely-located data store 30 at step 128. However, if no connectivity is available at step 126, processor 21 causes the fill data to be stored locally in memory 26 at step 130. Device 20 then continuously or periodically performs connectivity monitoring step 126 (e.g., as a background processing function) in order to automatically transmit any fill data stored locally at step 130.

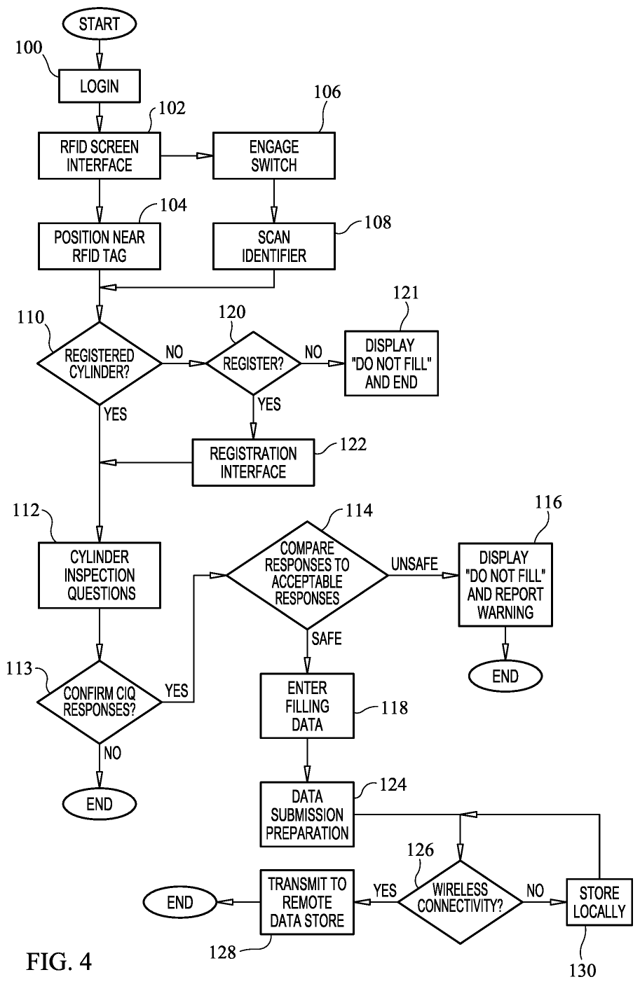

In other embodiments of the present invention, a fill operator could be required to actively attest to their user-supplied responses to the above-described CIQs. For example and as illustrated in FIG. 4, a user can be presented with an attestation interface at step 113 where the user must actively confirm their responses to the CIQs presented and answered in step 112. If the user confirms their responses at step 113, processing proceeds to the discrepancy check at step 114. If the user does not actively confirm their responses to the CIQs, processing ends for the particular cylinder. Such active attestation could require entry of a user's employee number, their signature, etc.

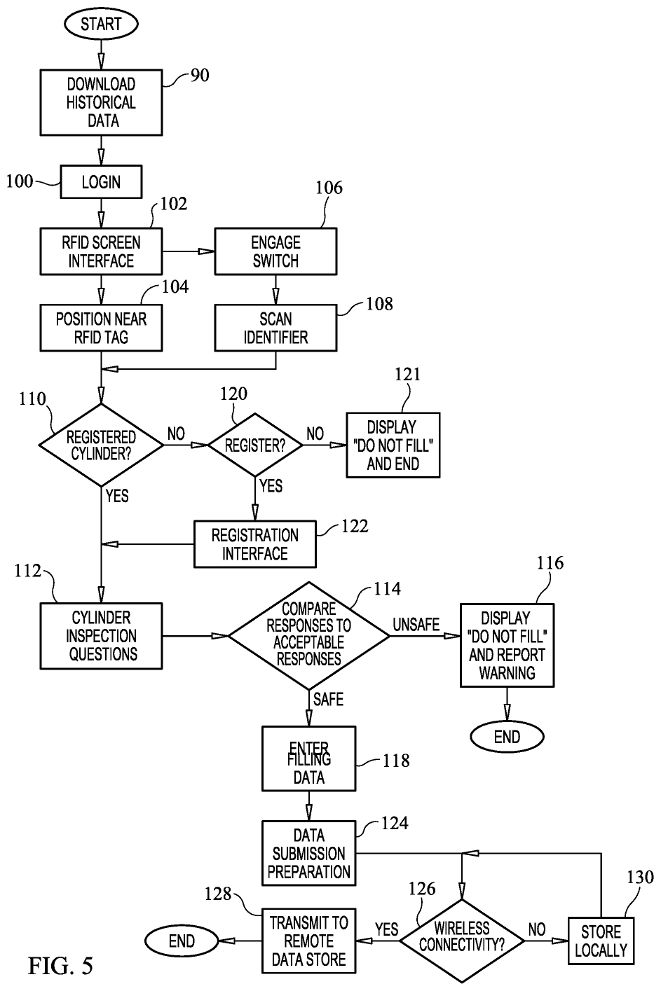

In other embodiments of the present invention, all historical data for a gas cylinder owner's cylinders can be downloaded to device 20 when device 20 is turned on and has access to data store 30. For example and as illustrated in FIG. 5, step 90 automatically downloads all historical data stored at data store 30 for all owned cylinders prior to login step 100. In this way, data store 30 does not need to be repeatedly accessed and a fill operator can proceed with the remainder of the process steps described herein even if internet connectivity is subsequently interrupted.

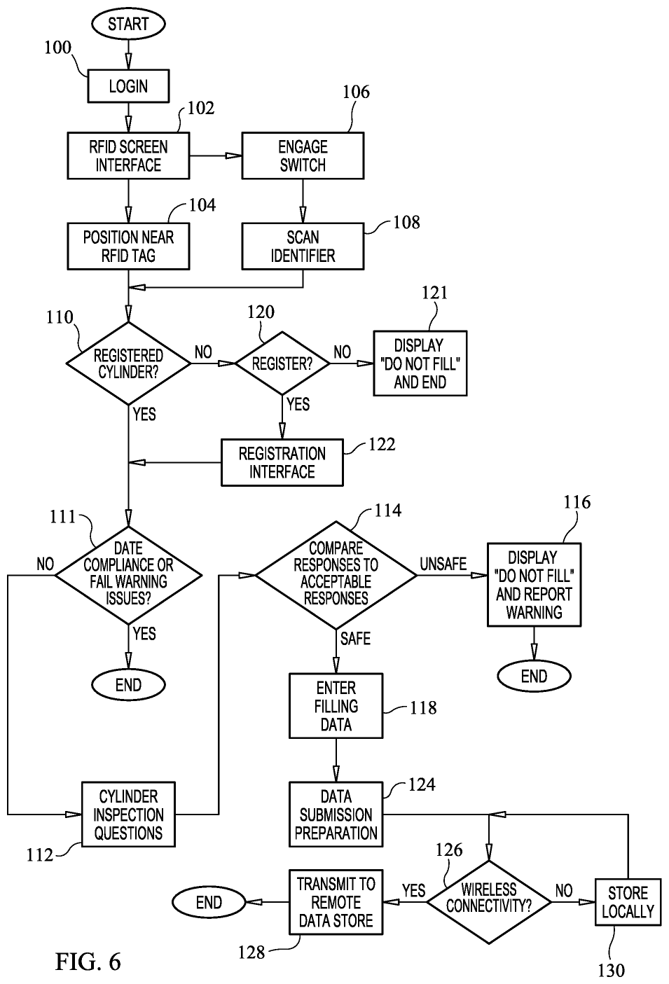

In other embodiments of the present invention, a cylinder's date compliance as well as its fail warning history can be used to prevent further fill processing for a cylinder. For example and as illustrated in FIG. 6, step 111 checks the cylinder's historical data to see if the identified cylinder is past its expiration date, is overdue for its hydrostatic or other safety test, or has a previously-recorded cylinder-fail warning associated therewith owing to previous CIQ discrepancies as explained earlier herein. If the identified cylinder has any date/test compliance or fail warning issues associated therewith, step 111 causes processing to end for the particular cylinder.

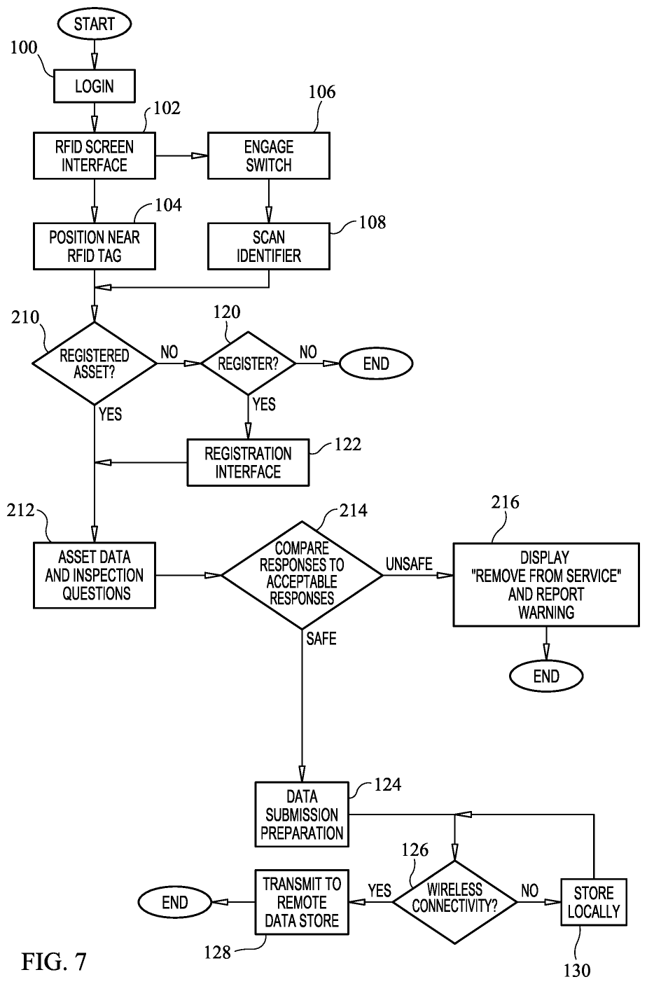

As mentioned above, the present invention can be adapted for management of the safety aspects of other critical assets used in breathing-air systems. Such assets can include, for example, the .compressors used to fill breathing-air cylinders, the air packs and masks that are coupled to a breathing-air cylinder to allow a user to receive the breathing air, physical cylinder support assets on which a breathing-air cylinder is typically mounted to facilitate the wearing thereof during an operation, and specially-designed clothing worn by a user during an operation requiring the use of a breathing-air system. Accordingly and with simultaneous reference now to FIGS. 1 and 7, an exemplary processing flow executed by device 20 for non-cylinder breathing-air assets is shown. For non-cylinder assets, the operator of device 20 is performing a safety inspection of the assets. Just like the previously-described cylinder fill operation, the processing methodology for non-cylinder assets is also incorporated into computer-executable instructions stored on device 20 and executed by processor 21. The features of the processing methodology that are the same as those already described herein are indicated with the same reference numerals.

At the start of processing, a user enters login credentials at step 100 using touch screen display 22. Following a properly validated login event, step 102 causes display 22 to present a screen/interface that assumes the asset that is to be inspected has an RFID tag (not shown) coupled thereto. Such login processing and validation operations are well understood in the art.

Assuming the asset has an RFID tag coupled thereto, an operator (or “user”) is instructed at step 104 to position device 20 close to the RFID tag whereby RFID reader 23 can read the RFID tag's identifier. Such instruction can come via a visual cue presented on display 22 and/or using an audible or tactile cue. Switch 25 can be set to a default position that selects RFID reader 23 as the data-reading input device of device 20 since many assets have RIFD tags affixed or coupled thereto.

If the asset does not have an RFID tag associated therewith, it will still generally have a serial number affixed thereto. As mentioned above, any alternative identifier (e.g., tag, code, number, etc.) capable of being read by optical scanner 24 is acceptable. When this scenario is presented to the user, switch 25 is engaged at step 106 to select optical scanner 24 as the data-reading input device for device 20. Switch 25 can be any of a variety of user-controlled switch devices (e.g., toggle switch, shake-activated switch, etc.) without departing from the scope of the present invention. Once optical scanner 24 is selected, the user is instructed at step 108 to position device 20 to scan the identifier on the asset. Such instruction can come via a visual cue presented on display 22 and/or using an audible or tactile cue.

The asset's identifier read at either step 104 or 108 is used to query remotely-located data store 30 at step 210 to see if the asset is registered. Briefly, processor 21 passes the asset's identifier to wireless interface 27 for transmission to remotely-located data store 30 that, in turn, compares the asset's identifier with those already stored in the data store's database. Remotely-located data store 30 provides a transmission back to device 20 to indicate if the asset is already registered or if it is not registered. If the asset's identifier is registered in the aforementioned database and there is no previously-recorded inspection failure warning (to be explained further below) associated with the identified asset, processor 21 causes display 22 to present the user with a number of prompts. The prompts can specify information about the asset that is to be verified (also referred to herein as “asset data”) as well as “asset inspection questions” at step 212. The asset data and inspection questions (or ADIQs) list a series of critical visual or other asset verification and inspection criteria that must be answered/attested to by the user. The ADIQs can be configured/customized based on the type of asset as well as a regulatory entity's requirements and, if desired, based on a customer's needs and/or policies. For example, the ADIQs can range from a simple question (e.g., “Did the asset pass the daily inspection in accordance with NFPA criteria?”) to a more detailed set of visual and/or mechanical or electrical inspection questions. In addition, the ADIQs could be directed to asking a user to verify that an asset is a particular model number(s) as a means to assure that outdated equipment is removed from service. All ADIQs can be framed to be responded to with a “YES” or “NO” response.

A user must respond to all ADIQs before the process will flow to its next step. In this way, the user-supplied responses can serve as a passive type of attestation to the stated inspection criteria. Active user attestation can also be employed as part of the asset inspection process in the same fashion as explained earlier herein with reference to FIG. 4. Once all ADIQs have been answered, processor 21 compares (at step 214) the user-supplied responses to pre-determined acceptable responses to the ADIQs where the acceptable responses are indicative of a safe asset. Processor 21 identifies if there are any discrepancies between the user-supplied responses to the ADIQs and the pre-determined acceptable responses. For example, if all ADIQs are constructed to have a YES or NO answer and at least one user-supplied response does not match the predetermined acceptable response, a discrepancy is identified.

In cases where one or more discrepancies are identified, device 20 generates an asset-fail warning indicator indicative of an unsafe asset and displays a warning message on display 22 (e.g., a “REMOVE FROM SERVICE” message). Device 20 then transmits the user-supplied responses along with the asset-fail warning indicator for the particular asset to remotely-located data store 30 via wireless interface 27 at step 216 and processing ends for the particular cylinder. In this way, the historical data associated with the particular asset stored at data store 30 is updated such that the asset is notated for repair or removal from service. The updated historical data is available immediately for review by asset owner administrators having access to data store 30.

Referring again to step 210, if an asset's identifier (e.g., RFID identifier, asset serial number, etc.) is not registered in the remotely-located database, the user is given the option to register the asset at step 120. If the user elects not to register the cylinder and registration is mandatory, processing in accordance with the present invention ends for the asset. If registration is desired, a registration interface is presented on display 22 at step 122 with user-entered information transmitted to the remotely-located database and processing then proceeds to step 212. The user-entered information can include any information related to the asset's safe operation and use. Registration interface 122 can include instructions for a user to associate a new RFID tag with the asset's serial number for future identification. If registration of the asset is not mandatory, processing is allowed to proceed to the above-described step 212 where ADIQs are presented on display 22 and the entered data to include the asset's serial number is tagged as an “UNREGISTERED ASSET” for ultimate transmission to the remotely-located database.

User-supplied response data to the ADIQs from step 212 is prepared for submission at step 124. For example, the present invention can prepare the user-supplied response data for cooperation with a unique “handshake” operation to insure the integrity of the data reporting and logging made possible by device 20. Briefly, the collected data associated with an asset can be transferred to data store 30 using any secure data transfer protocol as would be well-understood in the art. Additionally or alternatively, submission preparation step 124 could include the automatic association of a permanent current-date stamp with the user-supplied response data to thereby provide confidence in the reported response data.

After the user-supplied response data is prepared for submission, device 20 (via processor 21 and wireless interface 27) monitors the availability of wireless connectivity at step 126. For example, if an internet connection is available, processor 21 issues instructions to wireless interface 27 to transmit the user-supplied response data to remotely-located data store 30 at step 128. However, if no connectivity is available at step 126, processor 21 causes the user-supplied response data to be stored locally in memory 26 at step 130. Device 20 then continuously or periodically performs connectivity monitoring step 126 (e.g., as a background processing function) in order to automatically transmit any user-supplied response data stored locally at step 130.

The non-cylinder asset management methodology facilitated by device 20 can be supplemented with one or more of the additional features described and illustrated above with reference to FIGS. 4-6. That is, the computer-executable instructions can include one or more of the active attestation of all ADIQs following step 212 (FIG. 4), the automatic download (prior to login) of historical data for all of a customer's assets to device 20 when device 20 is turned on and has access to data store 30 (FIG. 5), and the check of an asset's compliance and/or fail warning history immediately after the asset's registration is identified or completed (FIG. 6).

Summarizing, the essential points of the present invention are presented in the following numbered items:
1. A mobile device for managing safety aspects associated with assets of compressed gas systems, comprising:
   a memory for storing computer-executable instructions;
   a processor operatively coupled to said memory for executing said computer-executable instructions; and
   a plurality of components operatively coupled to said processor for operating in accordance with said computer-executable instructions, said components including:
   a display component adapted to display prompts in accordance with said computer-executable instructions, said prompts including asset-inspection-criteria prompts,
   an input component adapted to receive user-supplied responses to said prompts,
   a reading component adapted to capture a unique identifier coupled to and associated with an asset, and
   a wireless interface component adapted to send and receive data over a wireless network,
   wherein said responses are associated with the unique identifier of the asset and are transmitted over the wireless network via said wireless interface component for inclusion with historical data associated with the asset maintained at a remote data store.
2. A mobile device as in item 1,
   wherein said processor is configured by said computer-executable instructions for identifying discrepancies between said responses to said asset-inspection-criteria prompts and pre-determined acceptable responses to said asset-inspection-criteria prompts,
   wherein, when said discrepancies are identified, said processor is configured by said computer-executable instructions to display a warning on said display component, and
   wherein an indication of said warning is associated with the unique identifier of the asset and is transmitted over the wireless network via said wireless interface component for inclusion with the historical data associated with the asset.
3. A mobile device as in any of items 1 to 2, wherein said processor is configured by said computer-executable instructions to require a user-supplied confirmation response at said input component following receipt of said responses to said asset-inspection-criteria prompts.
4. A mobile device as in any of items 1 to 3,
   wherein the asset is a compressed-gas cylinder,
   wherein said processor is configured by said computer-executable instructions for identifying discrepancies between said responses to said asset-inspection-criteria prompts and pre-determined acceptable responses to said asset-inspection-criteria prompts, and
   wherein, when said discrepancies are identified, said processor is configured by said computer-executable instructions to display a warning on said display component and to prevent display of filling data associated with the compressed-gas cylinder on said display component.
5. A mobile device as in any of items 1 to 4, wherein said processor is configured by said computer-executable instructions for storing said responses associated with the unique identifier of the asset at said mobile device when the wireless network is unavailable.
6. A mobile device as in any of items 1 to 5, wherein said processor is configured by said computer-executable instructions to download the historical data associated with the asset from the remote data store to said mobile device.
7. A method of managing safety aspects associated with assets of a compressed gas system, comprising the steps of:
   capturing, by a mobile electronic device, a unique identifier coupled to and associated with an asset of a compressed gas system;
   establishing, by the mobile electronic device, a wireless connection with a remote database storing historical data associated with the asset;
   displaying, by the mobile electronic device, prompts related to the asset, said prompts including asset-inspection-criteria prompts;
   receiving, by the mobile electronic device, user-supplied responses to said prompts; and
   transmitting, by the mobile electronic device, said responses via the wireless connection to the remote database for inclusion with the historical data associated with the asset.
8. A method according to item 7, further comprising the steps of:
   identifying, by the mobile electronic device, discrepancies between said responses to said asset-inspection-criteria prompts and pre-determined acceptable responses to said asset-inspection-criteria prompts;
   outputting, by the mobile electronic device, a warning when said discrepancies are identified; and
   transmitting, by the mobile electronic device, an indication of said warning with the unique identifier of the asset for inclusion with the historical data associated with the asset.
9. A method according to any of items 7 to 8, wherein the asset is a compressed-gas cylinder and said method further comprises the steps of:
   identifying, by the mobile electronic device, discrepancies between said responses to said asset-inspection-criteria prompts and pre-determined acceptable responses to said asset-inspection-criteria prompts;
   outputting, by the mobile electronic device, a warning when said discrepancies are identified; and
   preventing, by the mobile electronic device, display of filling data associated with the compressed-gas cylinder when said discrepancies are identified.
10. A method according to any of items 7 to 9, further comprising the step of requiring a user-supplied confirmation response at the mobile electronic device following receipt of said responses to said asset-inspection-criteria prompts.
11. A method according to any of items 7 to 10, further comprising the step of storing, by the mobile electronic device, said responses associated with the unique identifier of the asset when the wireless connection is unavailable.
12. A method according to any of items 7 to 11, further comprising the step of downloading the historical data associated with the asset from the remote database to the mobile electronic device.

The advantages of the present invention are numerous. The mobile device and system simplify the recording and reporting of data related to the safety of critical assets and operations associated with compressed gas systems. By requiring an operator to manually enter and attest to critical pass/fail inspection criteria, the present invention greatly reduces the chance that a faulty asset will be kept in service. Further, an asset failing the inspection criteria has its identifier automatically recorded in a remote database to warn against its use in the future by the other operators who utilize the present invention.

Although the invention has been described relative to specific embodiments thereof, there are numerous variations and modifications that will be readily apparent to those skilled in the art in light of the above teachings. For example, the device's touch screen could be replaced by dedicated/separate display and input devices without departing from the scope of the present invention. In other embodiments of the present invention, a registered and currently compliant asset's historical data could be presented on the mobile device's display following step 110 for review by the user. Furthermore, the capabilities of one or more of the features described in the additional embodiments could be incorporated into the device and system of the present invention without departing from the scope thereof. It is therefore to be understood that, within the scope of the appended claims, the invention may be practiced other than as specifically described.

What is claimed as new and desired to be secured by Letters Patent of the United States is:

1. A mobile device for managing safety aspects associated with assets of compressed gas systems, comprising:
a memory for storing computer-executable instructions;
a processor operatively coupled to said memory for executing said computer-executable instructions; and
a plurality of components operatively coupled to said processor for operating in accordance with said computer-executable instructions, said components including:
a display component adapted to display prompts in accordance with said computer-executable instructions, said prompts including asset-inspection-criteria prompts,
an input component adapted to receive user-supplied responses to said prompts,
a reading component adapted to capture a unique identifier coupled to and associated with an asset, and
a wireless interface component adapted to send and receive data over a wireless network,
wherein said responses are associated with the unique identifier of the asset and are transmitted over the wireless network via said wireless interface component for inclusion with historical data associated with the asset maintained at a remote data store.

2. A mobile device as in claim 1,
wherein said processor is configured by said computer-executable instructions for identifying discrepancies between said responses to said asset-inspection-criteria prompts and pre-determined acceptable responses to said asset-inspection-criteria prompts,
wherein, when said discrepancies are identified, said processor is configured by said computer-executable instructions to display a warning on said display component, and
wherein an indication of said warning is associated with the unique identifier of the asset and is transmitted over the wireless network via said wireless interface component for inclusion with the historical data associated with the asset.

3. A mobile device as in claim 1, wherein said processor is configured by said computer-executable instructions to require a user-supplied confirmation response at said input component following receipt of said responses to said asset-inspection-criteria prompts.

4. A mobile device as in claim 1,
wherein the asset is a compressed-gas cylinder,
wherein said processor is configured by said computer-executable instructions for identifying discrepancies between said responses to said asset-inspection-criteria prompts and pre-determined acceptable responses to said asset-inspection-criteria prompts, and
wherein, when said discrepancies are identified, said processor is configured by said computer-executable instructions to display a warning on said display component and to prevent display of filling data associated with the compressed-gas cylinder on said display component.

5. A mobile device as in claim 1, wherein said processor is configured by said computer-executable instructions for storing said responses associated with the unique identifier of the asset at said mobile device when the wireless network is unavailable.

6. A mobile device as in claim 1, wherein said processor is configured by said computer-executable instructions to download the historical data associated with the asset from the remote data store to said mobile device.

7. A mobile device as in claim 4, wherein an indication of said warning is associated with the unique identifier of the compressed-gas cylinder and is transmitted over the wireless network via said wireless interface component for inclusion with the historical data associated with the compressed-gas cylinder.

8. A mobile device as in claim 1, wherein said reading component comprises an RFID reader and an optical scanner, said mobile device further comprising a user-controlled switch for operatively coupling one of said RFID reader and said optical scanner to said processor.

9. A method of managing safety aspects associated with assets of a compressed gas system, comprising the steps of:
capturing, by a mobile electronic device, a unique identifier coupled to and associated with an asset of a compressed gas system;
establishing, by the mobile electronic device, a wireless connection with a remote database storing historical data associated with the asset;
displaying, by the mobile electronic device, prompts related to the asset, said prompts including asset-inspection-criteria prompts;
receiving, by the mobile electronic device, user-supplied responses to said prompts; and
transmitting, by the mobile electronic device, said responses via the wireless connection to the remote database for inclusion with the historical data associated with the asset.

10. A method according to claim 9, further comprising the steps of:
identifying, by the mobile electronic device, discrepancies between said responses to said asset-inspection-criteria prompts and pre-determined acceptable responses to said asset-inspection-criteria prompts;
outputting, by the mobile electronic device, a warning when said discrepancies are identified; and
transmitting, by the mobile electronic device, an indication of said warning with the unique identifier of the asset for inclusion with the historical data associated with the asset.

11. A method according to claim 9, wherein the asset is a compressed-gas cylinder and said method further comprises the steps of:
identifying, by the mobile electronic device, discrepancies between said responses to said asset-inspection-criteria prompts and pre-determined acceptable responses to said asset-inspection-criteria prompts;
outputting, by the mobile electronic device, a warning when said discrepancies are identified; and
preventing, by the mobile electronic device, display of filling data associated with the compressed-gas cylinder when said discrepancies are identified.

12. A method according to claim 11, further comprising the step of associating, by the mobile electronic device, an indication of said warning with the unique identifier of the compressed-gas cylinder for inclusion with the historical data associated therewith.

13. A method according to claim 9, further comprising the step of requiring a user-supplied confirmation response at the mobile electronic device following receipt of said responses to said asset-inspection-criteria prompts.

14. A method according to claim 9, further comprising the step of storing, by the mobile electronic device, said responses associated with the unique identifier of the asset when the wireless connection is unavailable.

15. A method according to claim 9, further comprising the step of downloading the historical data associated with the asset from the remote database to the mobile electronic device.

16. A non-transitory computer-readable medium having computer-executable instructions stored thereon that, in response to execution, cause a mobile electronic device including a processor to perform operations, comprising:
capturing a unique identifier coupled to and associated with an asset of a compressed gas system using one of an RFID reader and an optical scanner integrated with the mobile electronic device;
establishing a wireless connection with a remote database storing historical data associated with the asset using a wireless transceiver integrated with the mobile electronic device;
displaying prompts related to the asset on a display integrated with the mobile electronic device, said prompts including asset-inspection-criteria prompts;
receiving user-supplied responses to said prompts at an input device integrated with the mobile electronic device; and
transmitting said responses via the wireless connection to the remote database for inclusion with the historical data associated with the asset using the wireless transceiver.

17. A non-transitory computer-readable medium as in claim 16, wherein the operations further comprise:
identifying discrepancies between said responses to said asset-inspection-criteria prompts and pre-determined acceptable responses to said asset-inspection-criteria prompts;
outputting a warning on the display when said discrepancies are identified; and
transmitting an indication of said warning with the unique identifier of the asset via the wireless connection for inclusion with the historical data associated with the asset.

18. A non-transitory computer-readable medium as in claim 16, wherein the asset is compressed-gas cylinder and the operations further comprise:
identifying discrepancies between said responses to said asset-inspection-criteria prompts and pre-determined acceptable responses to said asset-inspection-criteria prompts;
outputting a warning on the display when said discrepancies are identified; and
preventing display of filling data associated with the compressed-gas cylinder on the display when said discrepancies are identified.

19. A non-transitory computer-readable medium as in claim 18, wherein the operations further comprise associating an indication of said warning with the unique identifier of the compressed-gas cylinder for inclusion with the historical data associated therewith.

20. A non-transitory computer-readable medium as of claim 16, wherein the operations further comprise requiring a user-supplied confirmation response at the mobile electronic device following receipt of said responses to said asset-inspection-criteria prompts.

21. A non-transitory computer-readable medium as of claim 16, wherein the operations further comprise downloading the historical data associated with the asset from the remote database to the mobile electronic device.

22. A system for managing safety aspects associated with assets of compressed gas systems, comprising:
a mobile device that includes
a memory for storing computer-executable instructions,
a processor operatively coupled to said memory for executing said computer-executable instructions, and
a plurality of components operatively coupled to said processor for operating in accordance with said computer-executable instructions, said components including
a display component adapted to display prompts in accordance with said computer-executable instructions, said prompts including asset-inspection-criteria prompts,
an input component adapted to receive user-supplied responses to said prompts,
a reading component adapted to capture a unique identifier coupled to and associated with an asset of a compressed gas system, and
a wireless interface component adapted to send and receive data over a wireless network; and
a remote data store, accessible via the wireless network, for storing historical data associated with the asset,
wherein said processor associates said responses with the unique identifier of the asset for subsequent transmission over the wireless network via said wireless interface component for inclusion with the historical data associated with the asset maintained at said remote data store.

23. A system as in claim 22,
wherein said processor is configured by said computer-executable instructions for identifying discrepancies between said responses to said asset-inspection-criteria prompts and pre-determined acceptable responses to said asset-inspection-criteria prompts,
wherein, when said discrepancies are identified, said processor is configured by said computer-executable instructions to display a warning on said display component, and
wherein an indication of said warning is associated with the unique identifier of the asset and is transmitted over the wireless network via said wireless interface component for inclusion with the historical data associated with the asset.

24. A system as in claim 22,
wherein the asset is a compressed-gas cylinder,
wherein said processor is configured by said computer-executable instructions for identifying discrepancies between said responses to said asset-inspection-criteria prompts and pre-determined acceptable responses to said asset-inspection-criteria prompts, and
wherein, when said discrepancies are identified, said processor is configured by said computer-executable instructions to display a warning on said display component and to prevent display of filling data associated with the compressed-gas cylinder on said display component.

25. A system as in claim 24, wherein an indication of said warning is associated with the unique identifier of the compressed-gas cylinder and is transmitted over the wireless network via said wireless interface component for inclusion with the historical data associated with the compressed-gas cylinder.

26. A system as in claim 22, wherein said processor is configured by said computer-executable instructions to require a user-supplied confirmation response at said mobile device following receipt of said responses to said asset-inspection-criteria prompts.

27. A system as in claim 22, wherein said processor is configured by said computer-executable instructions for storing said responses associated with the unique identifier of the asset at said mobile device when the wireless network is unavailable.

28. A system as in claim 22, wherein said processor is configured by said computer-executable instructions to download the historical data associated with the asset from the remote data store to said mobile device.
